(19) United States
(12) Patent Application Publication
(10) Pub. No.: US 2024/0120965 A1
(43) Pub. Date: Apr. 11, 2024

(54) WIRELESS COMMUNICATION SYSTEM, WIRELESS COMMUNICATION METHOD, AND RECORDING MEDIUM

(71) Applicant: NEC Corporation, Tokyo (JP)

(72) Inventors: Norifumi KAMIYA, Tokyo (JP); Eisaku Sasaki, Tokyo (JP)

(73) Assignee: NEC Corporation, Tokyo (JP)

(21) Appl. No.: 18/371,675

(22) Filed: Sep. 22, 2023

(30) Foreign Application Priority Data
Sep. 29, 2022 (JP) 2022-155974

(51) Int. Cl. H04B 7/01; H04B 7/0456

(52) U.S. Cl. CPC H04B 7/01; H04B 7/0479

(57) ABSTRACT

A wireless communication system includes: a transmission apparatus that transmits a wireless signal including a plurality of wireless transmission signals, by using a plurality of transmitting antenna elements; and a reception apparatus that receives the wireless signal, as a plurality of wireless reception signals, by using a plurality of receiving antenna elements. The reception apparatus generates a plurality of separated reception signals by performing a signal separation process on the plurality of wireless reception signals, generates correlation information about the separated reception signals, and generates phase control information on the basis of the correlation information. The transmission apparatus generates the plurality of synthesized transmission signals by performing the signal synthesis process on the plurality of transmission signals, and adjusts the phase of each of the synthesized transmission signals, by a phase shift amount calculated on the basis of the phase control information.

### INCORPORATION BY REFERENCE

This application is based upon and claims the benefit of priority from Japanese Patent Application No. 2022-155974, filed on Sep. 29, 2022, the disclosure of which is incorporated herein in its entirety by reference.

### TECHNICAL FIELD

Example embodiments of this disclosure relate to technical fields of a wireless communication system, a wireless communication method, and a recording medium that perform wireless communication using a Multi Input Multi Output (MIMO) transmission technique/technology.

### BACKGROUND ART

In recent years, studies have been underway on the wireless communication system that performs wireless communication using the MIMO transmission technique/technology (hereinafter referred to as “MIMO wireless communication”). Examples of the wireless communication system that performs the MIMO wireless communication are disclosed in Patent Literatures 1 to 5 and Non-Patent Literatures 1 and 2.

### PRIOR ART DOCUMENTS

### Patent Literature

[Patent Literature 1] International Publication No. WO2019/189704 pamphlet
[Patent Literature 2] International Publication No. WO2017/057725 pamphlet
[Patent Literature 3] JP2014-526191A
[Patent Literature 4] JP2016-115976A
[Patent Literature 5] JP2015-043610A

### Non-Patent Literature

[Non-Patent Literature 1] Frode Bohagen et al., “Design of Optimal High-Rank Line-of-Sight MIMO Channels”, IEEE Transactions on Wireless Communications, Vol. 6, No. 4, pp. 1420-1425, April 2007
[Non-Patent Literature 2] Ove Edfors et al., “Is Orbital Angular Momentum (OAM) Based Wireless communication an Unexploited Area?”, IEEE Transactions on Antennas and Propagation, Vol. 60, No. 2, pp. 1126-1131, February 2012

A communication capacity of the MIMO communication performed in a line-of-sight environment depends on a relative positional relationship between a plurality of transmitting antenna elements provided in a transmission apparatus and a plurality of receiving antenna elements provided in a reception apparatus. Generally, the plurality of transmitting antenna elements and the plurality of receiving antenna elements are arranged to maximize the communication capacity under a given antenna installation condition. When, however, the relative positional relationship between the plurality of transmitting antenna elements and the plurality of receiving antenna elements, is changed from an ideal positional relationship due to external factors, such as wind and weather and vibration, the communication capacity is lowered. Therefore, it is desirable to detect a change in the relative positional relationship between the plurality of transmitting antenna elements and the plurality of receiving antenna elements, and to reduce an influence on the communication capacity caused by the detected change.

Patent Literature 1 discloses a method of detecting the change in the relative positional relationship between the plurality of transmitting antenna elements and the plurality of receiving antenna elements, in the MIMO wireless communication that utilizes an Orbital Angular Momentum (OAM) mode by using a Uniform Circular Array (UCA) antenna in which the plurality of transmitting antenna elements are arranged on a circumference of the antenna and a UCA antenna in which the plurality of receiving antenna elements are arranged on a circumference of the antenna. A situation where the method disclosed in Patent Literature 1 is performed, however, is limited to a situation where the MIMO wireless communication that utilizes the OAM mode by using the UCA antenna. Therefore, in the method disclosed in Patent Literature 1, it is hardly possible to detect the change in the relative positional relationship between the plurality of transmitting antenna elements and the plurality of receiving antenna elements in each of a case where the UCA antenna is not used, and a case where the OAM mode is not utilized. Consequently, the method disclosed in Patent Literature 1 has such a technical problem that it is hardly possible to properly reduce the influence on the communication capacity caused by the change in the relative positional relationship between the plurality of transmitting antenna elements and the plurality of receiving antenna elements.

### SUMMARY

It is an example object of this disclosure to provide a wireless communication system, a wireless communication method, and a recording medium that are capable of solving the above-described technical problems. It is also an example object of this disclosure to provide a wireless communication system, a transmission apparatus, a reception apparatus, a wireless communication method, and a recording medium that are capable of properly reducing the influence on the communication capacity caused by the change in the relative positional relationship between the plurality of transmitting antenna elements and the plurality of receiving antenna elements.

A wireless communication system according to an example aspect of this disclosure is a wireless communication system including: a transmission apparatus that generates a plurality of synthesized transmission signals by performing a signal synthesis process on a plurality of transmission signals, and that transmits a wireless signal including a plurality of wireless transmission signals generated from the plurality of synthesized transmission signals, by using a plurality of transmitting antenna elements; and a reception apparatus that receives the wireless signal transmitted by the transmission apparatus, as a plurality of wireless reception signals, by using a plurality of receiving antenna elements, the reception apparatus including: a reception signal generation unit that generates a plurality of separated reception signals by performing a signal separation process on the plurality of wireless reception signals; a correlation information generation unit that generates correlation information indicating a correlation among the plurality of separated reception signals; a phase control information generation unit that generates phase control information indicating a relationship between a phase of each of the plurality of synthesized transmission signals and a communication capacity, on the basis of the correlation information; and a transmission unit that transmits the phase control information to the transmission apparatus, the transmission apparatus including: a reception unit that receives the phase control information transmitted by the transmission unit; a transmission signal generation unit that generates the plurality of synthesized transmission signals by performing the signal synthesis process on the plurality of transmission signals; a phase calculation unit that calculates a phase shift amount indicating a shift amount of the phase of each of the plurality of synthesized transmission signals, on the basis of the phase control information received by the reception unit; and a phase adjustment unit that adjusts the phase of each of the plurality of synthesized transmission signals, by the phase shift amount calculated by the phase calculation unit.

A wireless communication method according to an example aspect of this disclosure is a wireless communication method using: a transmission apparatus that generates a plurality of synthesized transmission signals by performing a signal synthesis process on a plurality of transmission signals, and that transmits a wireless signal including a plurality of wireless transmission signals generated from the plurality of synthesized transmission signals, by using a plurality of transmitting antenna elements; and a reception apparatus that receives the wireless signal transmitted by the transmission apparatus, as a plurality of wireless reception signals, by using a plurality of receiving antenna elements, the wireless communication method including: generating a plurality of separated reception signals by performing a signal separation process on the plurality of wireless reception signals; generating correlation information indicating a correlation among the plurality of separated reception signals; generating phase control information indicating a relationship between a phase of each of the plurality of synthesized transmission signals and a communication capacity, on the basis of the correlation information; generating the plurality of synthesized transmission signals by performing the signal synthesis process on the plurality of transmission signals; calculating a phase shift amount indicating a shift amount of the phase of each of the plurality of synthesized transmission signals, on the basis of the phase control information received by the reception unit; and adjusting the phase of each of the plurality of synthesized transmission signals, by the phase shift amount calculated by the phase calculation unit.

A recording medium according to an example aspect of this disclosure is a non-transitory recording medium on which a computer program that allows a computer to execute a wireless communication method is recorded, the wireless communication method using: a transmission apparatus that generates a plurality of synthesized transmission signals by performing a signal synthesis process on a plurality of transmission signals, and that transmits a wireless signal including a plurality of wireless transmission signals generated from the plurality of synthesized transmission signals, by using a plurality of transmitting antenna elements; and a reception apparatus that receives the wireless signal transmitted by the transmission apparatus, as a plurality of wireless reception signals, by using a plurality of receiving antenna elements, the wireless communication method including: generating a plurality of separated reception signals by performing a signal separation process on the plurality of wireless reception signals; generating correlation information indicating a correlation among the plurality of separated reception signals; generating phase control information indicating a relationship between a phase of each of the plurality of synthesized transmission signals and a communication capacity, on the basis of the correlation information; generating the plurality of synthesized transmission signals by performing the signal synthesis process on the plurality of transmission signals; calculating a phase shift amount indicating a shift amount of the phase of each of the plurality of synthesized transmission signals, on the basis of the phase control information received by the reception unit; and adjusting the phase of each of the plurality of synthesized transmission signals, by the phase shift amount calculated by the phase calculation unit.

### Effect

According to the wireless communication system, the wireless communication method, and the recording medium in the respective example aspects, it is possible to properly reduce the influence on the communication capacity caused by the change in the relative positional relationship between the plurality of transmitting antenna elements and the plurality of receiving antenna elements.

### BRIEF DESCRIPTION OF THE DRAWINGS

FIG. 1 is a block diagram illustrating an overall configuration of a wireless communication system according to an example embodiment;

FIG. 2 is a block diagram illustrating logical functional blocks realized or implemented in a signal processing apparatus of a reception apparatus to perform a reception operation;

FIG. 3 is a diagram illustrating an example of functional blocks realized or implemented in a communication state detection unit to generate correlation information;

FIG. 4 is a diagram illustrating an example of functional blocks realized or implemented in a phase control information generation unit to generate phase control information;

FIG. 5 is a block diagram illustrating logical functional blocks realized or implemented in a signal processing apparatus of a transmission apparatus to perform a transmission operation;

FIG. 6 is a diagram illustrating an example of functional blocks realized or implemented in a phase update unit to calculate phase shift amounts;

FIG. 7 is a flowchart illustrating a flow of the reception operation performed by the reception apparatus;

FIG. 8 is a flowchart illustrating a flow of an operation of generating the correlation information;

FIG. 9 is a flowchart illustrating a flow of an operation of generating the phase control information;

FIG. 10 is a flowchart illustrating a flow of the transmission operation performed by the transmission apparatus;

FIG. 11 is a flowchart illustrating a low of an operation of calculating the phase shift amounts;

FIG. 12 is a diagram illustrating an example of arrangement of transmitting antenna elements and receiving antenna elements;

FIG. 13 is a graph illustrating a time change in a communication capacity; and

FIG. 14 is a graph illustrating a time change in the phase shift amounts.

### EXAMPLE EMBODIMENT

Hereinafter, with reference to the drawings, a wireless communication system, a wireless communication method, and a recording medium according to an example embodiment will be described, by using a wireless communication system SYS to which the wireless communication system, the wireless communication method, and the recording medium according to the example embodiment are applied. The example embodiment of this disclosure, however, is not limited to the example embodiment described below.

### <1> Configuration of Wireless Communication System SYS

First, a configuration of the wireless communication system SYS according to the example embodiment will be described.

### <1-1> Overall Configuration of Wireless Communication System SYS

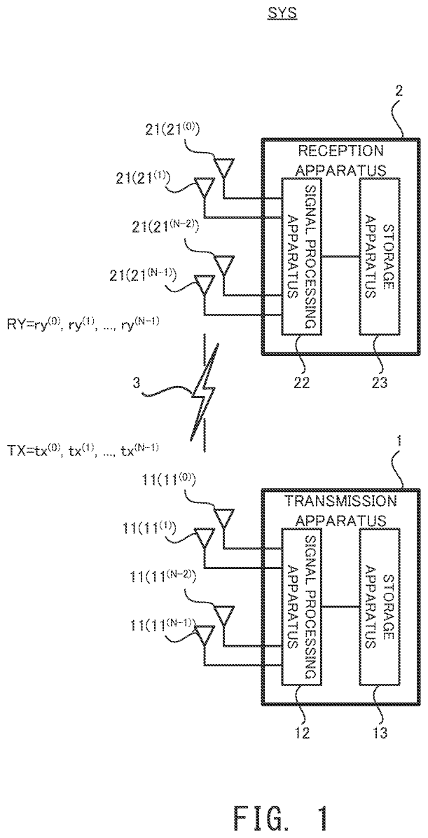

First, an overall configuration of the wireless communication system SYS according to the example embodiment will be described with reference to FIG. 1. FIG. 1 is a block diagram illustrating the overall configuration of the wireless communication system SYS according to the example embodiment.

As illustrated in FIG. 1, the wireless communication system SYS includes a transmission apparatus 1 and a reception apparatus 2. The wireless communication system SYS uses the transmission apparatus 1 and the reception apparatus 2 to perform wireless communication using a Multi Input Multi Output (MIMO) transmission technique/technology. Especially in the example embodiment, the wireless communication system SYS may perform the wireless communication using the MIMO transmission technique/technology in a line-of-sight environment (LOS environment). In the following description, the wireless communication using the MIMO transmission technique/technology will be referred to as “MIMO wireless communication”.

To perform the MIMO wireless communication, the transmission apparatus 1 includes a plurality of transmitting antenna elements 11. The transmission apparatus 1 uses the plurality of transmitting antenna elements 11, thereby to transmit a wireless signal TX including a plurality of wireless transmission signals tx, to the reception apparatus 2. The plurality of transmitting antenna elements 11 may be arranged on a circumference at the same intervals. In this instance, the plurality of transmitting antenna elements 11 may constitute a Uniform Circular Array (UCA) antenna. The plurality of transmitting antenna elements 11 may be arranged on a straight line at the same intervals. In this instance, the plurality of transmitting antenna elements 11 may constitute a Uniform Linear Array (ULA) antenna.

The following describes, for simplicity of explanation, an example in which the transmission apparatus 1 includes N transmitting antenna elements 11 (where N is a variable indicating an integer of 2 or more). In the following description, the N transmitting antenna elements 11 of the transmission apparatus 1 are respectively referred to as transmitting antenna elements 11⁽⁰⁾ to 11^{(N-1)}. The transmission apparatus 1 uses the N transmitting antenna elements 11⁽⁰⁾ to 11^{(N-1)} to transmit N wireless transmission signals tx. In the following description, the N wireless transmission signals tx transmitted by the N transmitting antenna elements 11⁽⁰⁾ to 11^{(N-1)} are referred to as wireless transmission signals tx⁽⁰⁾ to tx^{(N-1)}. That is, in the following description, a transmitting antenna element 11^{(k)} transmits a wireless transmission signal tx^{(k)} (where k is a variable indicating an integer that is greater than or equal to 0 and that is less than or equal to N−1).

The transmission apparatus 1 further includes a signal processing apparatus 12 and a storage apparatus 13.

The signal processing apparatus 12 may include at least one of a CPU (Central Processing Unit), a GPU (Graphic Processing Unit), and a FPGA (Field Programmable Gate Array). The signal processing apparatus 12 may read a computer program. For example, the signal processing apparatus 12 may read a computer program stored in the storage apparatus 13. For example, the signal processing apparatus 12 may read a computer program stored in a computer-readable recording medium, by using a not-illustrated recording medium reading apparatus. The signal processing apparatus 12 may obtain (i.e., download or read) a computer program from a not-illustrated apparatus disposed outside the transmission apparatus 1, through a not-illustrated communication apparatus. The signal processing apparatus 12 executes the read computer program. Consequently, a logical functional block for performing an operation to be performed by the transmission apparatus 1 is realized or implemented in the signal processing apparatus 12. Specifically, a logical functional block for performing a transmission operation of transmitting the wireless signal TX is realized or implemented in the signal processing apparatus 12. That is, the signal processing apparatus 12 is configured to function as a controller for realizing or implementing the logical functional block for performing the operation to be performed by the transmission apparatus 1.

The storage apparatus 13 is configured to store desired data. For example, the storage apparatus 13 may temporarily store a computer program to be executed by the signal processing apparatus 12. The storage apparatus 13 may temporarily store data that are temporarily used by the signal processing apparatus 12 when the signal processing apparatus 12 executes the computer program. The storage apparatus 13 may store data that are stored by the transmission apparatus 1 for a long term. The storage apparatus 13 may include at least one of a RAM (Random Access Memory), a ROM (Read Only Memory), a hard disk apparatus, a magneto-optical disk apparatus, a SSD (Solid State Drive), and a disk array apparatus.

To perform the MIMO wireless communication, the reception apparatus 2 includes a plurality of receiving antenna elements 21. The plurality of receiving antenna elements 21 are arranged to face the plurality of transmitting antenna elements 11. The reception apparatus 2 uses the plurality of receiving antenna elements 21, thereby to receive the wireless signal TX transmitted by the transmission apparatus 1, as a wireless signal RY including a plurality of wireless reception signals ry. The plurality of receiving antenna elements 21 may be arranged on a circumference at the same intervals. In this instance, the plurality of receiving antenna elements 21 may constitute a Uniform Circular Array (UCA) antenna. The plurality of receiving antenna elements 21 may be arranged on a straight line at the same intervals. In this instance, the plurality of receiving antenna elements 21 may constitute a Uniform Linear Array (ULA) antenna.

The following describes, for simplicity of explanation, an example in which the reception apparatus 2 includes N receiving antenna elements 21. In the following description, the N receiving antenna elements 21 of the reception apparatus 2 are respectively referred to as receiving antenna elements 21⁽⁰⁾ to 21^{(N-1)}. The reception apparatus 2 uses the receiving antenna elements 21⁽⁰⁾ to 21^{(N-1)} to receive N wireless reception signals ry that constitute the wireless signal RY In the following description, the N wireless reception signals ry received by the N receiving antenna elements 21⁽⁰⁾ to 21^{(N-1)} are referred to as wireless reception signals t ry⁽⁰⁾ to ry^{(N-1)}. That is, in the following description, a receiving antenna element 21^{(k)} receives a wireless reception signal ry).

The reception apparatus 2 further includes a signal processing apparatus 22 and a storage apparatus 23.

The signal processing apparatus 22 may include at least one of a CPU (Central Processing Unit), a GPU (Graphic Processing Unit), and a FPGA (Field Programmable Gate Array). The signal processing apparatus 22 may read a computer program. For example, the signal processing apparatus 22 may read a computer program stored in the storage apparatus 23. For example, the signal processing apparatus 22 may read a computer program stored in a computer-readable recording medium, by using a not-illustrated recording medium reading apparatus. The signal processing apparatus 22 may obtain (i.e., download or read) a computer program from a not-illustrated apparatus disposed outside the reception apparatus 2, through a not-illustrated communication apparatus. The signal processing apparatus 22 executes the read computer program. Consequently, a logical functional block for performing an operation to be performed by the reception apparatus 2 is realized or implemented in the signal processing apparatus 22. Specifically, a logical functional block for performing a reception operation of receiving the wireless signal RY is realized or implemented in the signal processing apparatus 22. That is, the signal processing apparatus 22 is configured to function as a controller for realizing or implementing the logical functional block for performing the operation to be performed by the reception apparatus 2.

The storage apparatus 23 is configured to store desired data. For example, the storage apparatus 23 may temporarily store a computer program to be executed by the signal processing apparatus 22. The storage apparatus 23 may temporarily store data that are temporarily used by the signal processing apparatus 22 when the signal processing apparatus 22 executes the computer program. The storage apparatus 23 may store data that are stored by the reception apparatus 2 for a long term. The storage apparatus 23 may include at least one of a RAM (Random Access Memory), a ROM (Read Only Memory), a hard disk apparatus, a magneto-optical disk apparatus, a SSD (Solid State Drive), and a disk array apparatus.

### <1-2> Configuration of Reception Apparatus 2 (Signal Processing Apparatus 22)

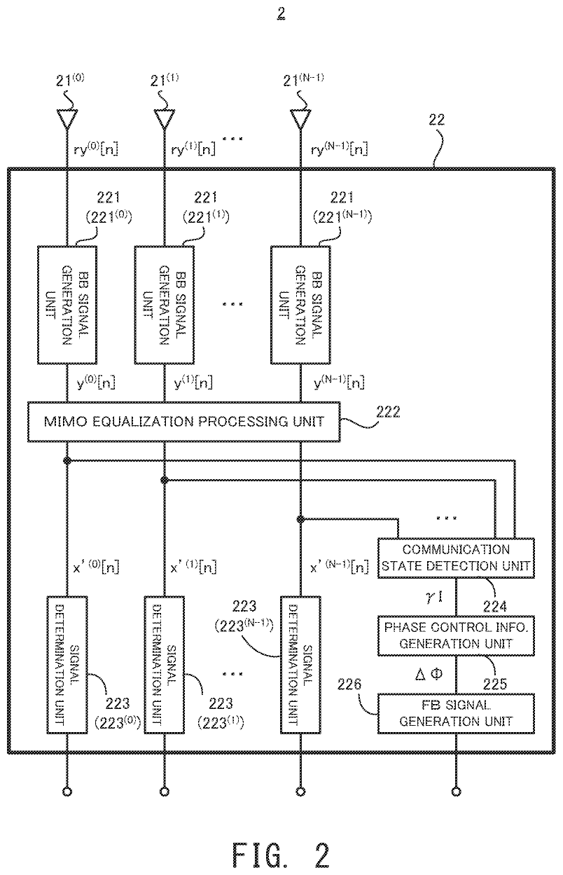

Next, with reference to FIG. 2, a configuration of the reception apparatus 2 in the example embodiment (especially, a configuration of the signal processing apparatus 22) will be described. FIG. 2 is a block diagram illustrating logical functional blocks realized or implemented in the signal processing apparatus 22 to perform the reception operation.

As illustrated in FIG. 2, the signal processing apparatus 22 includes, as the logical functional blocks for performing the reception operation, a plurality of baseband (BB) signal generation units 221, a MIMO equalization processing unit 222 that is a specific example of the “reception signal generation unit” in Supplementary Notes described later, a plurality of signal determination units 223, a communication state detection unit 224 that is a specific example of the “correlation information generation unit” in Supplementary Notes described later, a phase control information generation unit 225 that is a specific example of the “phase control information generation unit” in Supplementary Notes described later, and a feedback (FB) signal generation unit 226 that is a specific example of the “transmission unit” in Supplementary Notes described later.

FIG. 2 illustrates the logical functional blocks for performing the reception operation, merely conceptually (in other words, simply). That is, the functional blocks illustrated in FIG. 2 are not necessarily realized or implemented in the signal processing apparatus 22 as they are, and as long as the signal processing apparatus 22 is allowed to perform the operation performed by the functional blocks illustrated in FIG. 2, the configuration of the functional blocks realized or implemented in the signal processing apparatus 22 is not limited to the configuration illustrated in FIG. 2.

The plurality of baseband signal generation units 221 respectively generate a plurality of baseband signals y, from the plurality of wireless reception signals ry respectively received by the plurality of receiving antenna elements 21. As described above, the reception apparatus 2 receives the N wireless reception signals ry⁽⁰⁾ to ry^{(N-1)} by using the N receiving antenna elements 21⁽⁰⁾ to 21^{(N-1)}, respectively. Therefore, the reception apparatus 2 includes, as the plurality of baseband signal generation units 221, N baseband signal generation units 221⁽⁰⁾ to 221^{(N-1)} that respectively generate N baseband signals y⁽⁰⁾ to y^{(N-1)} from the N wireless reception signals ry⁽⁰⁾ to ry^{(N-1)}. In this instance, a baseband signal generation unit 221^{(k)} generates a baseband signal y^{(k)} from the wireless reception signal ry^{(k)}, respectively.

In particular, the N baseband signal generation units 221⁽⁰⁾ to 221^{(N-1)} respectively generate the baseband signals y⁽⁰⁾ to y^{(N-1)}, from the N wireless reception signals ry⁽⁰⁾ to ry^{(N-1)} received by the N receiving antenna elements 21⁽⁰⁾ to 21^{(N-1)} at a time n. n is a variable indicating a time by using an integer as an index. In the following description, the wireless reception signal ry^{(k)} received by the receiving antenna element 21^{(k)} at the time n is referred to as a wireless reception signal ry^{(k)}[n], and the baseband signal y^{(k)} generated from the wireless reception signal ry^{(k)}[n] by the baseband signal generation unit 221^{(k)} is referred to as a baseband signal y^{(k)}[n].

The baseband signal generation unit 221^{(k)} may generate the baseband signal y^{(k)}[n], by performing a predetermined wireless reception process on the wireless reception signal ry^{(k)}[n]. The predetermined wireless reception process may include, for example, at least one of a down-conversion process, an analog-to-digital conversion process, a filtering process and the like.

The MIMO equalization processing unit 222 performs a MIMO equalization process on baseband signals y⁽⁰⁾[n] to y^{(N-1)}[n]. Consequently, the MIMO equalization processing unit 222 generates a plurality of MIMO reception signals x′. Specifically, the MIMO equalization processing unit 222 generates MIMO reception signals x′⁽⁰⁾[n] to x′^{(N-1)}[n].

In the baseband signals y⁽⁰⁾[n] to y^{(N-1)}[n] generated by the reception apparatus 2 that performs the MIMO wireless communication, transmission signals x⁽⁰⁾[n] to x^{(N-1)}[n] transmitted to the reception apparatus 2 from the transmission apparatus 1 at the time n are mixed. In this instance, the MIMO equalization process may include a signal separation process for separating the transmission signals x⁽⁰⁾[n] to x^{(N-1)}[n] multiplexed by the MIMO wireless communication. When the MIMO equalization process includes the signal separated process, MIMO reception signals x′ may be referred to as separation reception signals.

Furthermore, in the baseband signals y⁽⁰⁾[n] to y^{(N-1)}[n] generated by the reception apparatus 2 that performs the MIMO wireless communication, an influence of interference generated in a transmission path 3 is included. An example of the interference generated in the transmission path 3 is multipath interference (MPI). In this instance, the MIMO equalization process may be a signal separation process that takes into account the interference generated in the transmission path 3. For example, the MIMO equalization process may include a process of compensating for the interference generated in the transmission path 3.

The MIMO equalization processing unit 222 may perform an existing MIMO equalization process. For example, the MIMO equalization processing unit 222 may perform a MIMO equalization process based on minimum mean square error (MMSE). For example, the MIMO equalization processing unit 222 may perform a MIMO equalization process based on zero forcing (ZF). In the following description, the MIMO equalization process based on the minimum mean square error is referred to as a MMSE process. Furthermore, in the following description, the MIMO equalization process based on the zero forcing is referred to as a ZF process.

The plurality of signal determination units 223 respectively estimate the transmission signals x transmitted to the reception apparatus 2 from the transmission apparatus 1, from the plurality of MIMO reception signals x′. Specifically, the reception apparatus 2 includes N signal determination units 223⁽⁰⁾ to 223^{(N-1)}. The signal determination units 223⁽⁰⁾ to 223^{(N-1)} respectively estimate the transmission signals x⁽⁰⁾[n] to x^{(N-1)}[n] transmitted to the reception apparatus 2 from the transmission apparatus 1 at the time n, from the MIMO reception signals x′⁽⁰⁾ to x′^{N-1}. That is, a signal determination unit 223^{(k)} estimates a transmission signal x^{(k)}[n] from a MIMO reception signal x′^{(k)}[n]. The reception apparatus 2 may estimate the transmission signals x by using an existing signal estimation method. Therefore, a detailed description of the signal estimation method performed by the signal determination unit 223^{(k)} will be omitted.

The signal determination unit 223^{(k)} may calculate an error signal (in other words, an error component) included in the MIMO reception signal x′^{(k)}[n], on the basis of an estimation result of the transmission signal x^{(k)}[n]. The signal determination unit 223^{(k)} may output (in other words, feed back) the calculated error signal to the MIMO equalization processing unit 222. The MIMO equalization processing unit 222 may calculate a tap coefficient matrix required to perform the MMSE process or the ZF process, on the basis of the error signal outputted from the signal determination unit 223^{(k)}.

The communication state detection unit 224 generates (in other words, calculates) correlation information γI indicating a correlation among the MIMO reception signals x′⁽⁰⁾ to x′^{(N-1)}. Specifically, the communication state detection unit 224 calculates a correlation γ_{i,j} between a MIMO reception signal x′⁽ⁱ⁾ and a MIMO reception signal x′^{(j)}. i is a variable indicating an integer that is greater than or equal to 0 and that is less than or equal to N−1. j is a variable indicating an integer that is greater than or equal to 0 and that is less than or equal to N−1, and that is greater than or equal to the variable i. When the variable i and the variable j are different, the correlation γ_{i,j} may be referred to as a cross-correlation. On the other hand, when the variable i and the variable j are the same, the correlation γ_{i,j} may be referred to as an autocorrelation.

The communication state detection unit 224 repeats the operation of calculating the correlation γ_{i,j}, while changing a combination pattern of the variable i and the variable j. Consequently, the communication state detection unit 224 generates the correlation information γI indicating N autocorrelations γ_{i,j} and N×(N−1)/2 cross-correlations γ_{i,j}. That is, the communication state detection unit 224 generates the correlation information γI indicating N×(N+1)/2 correlations γ_{i,j}.

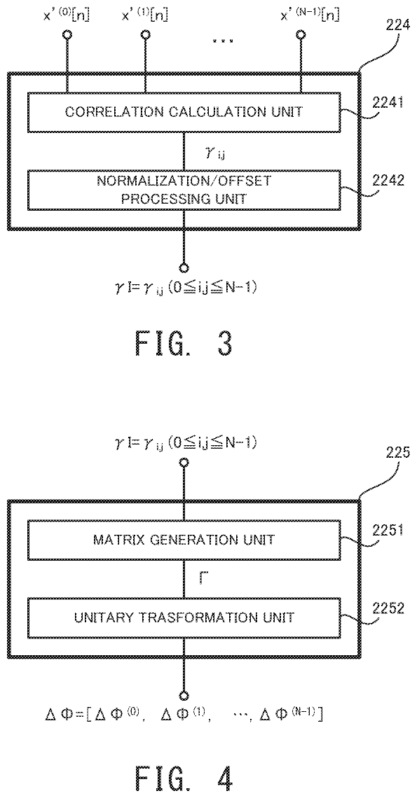

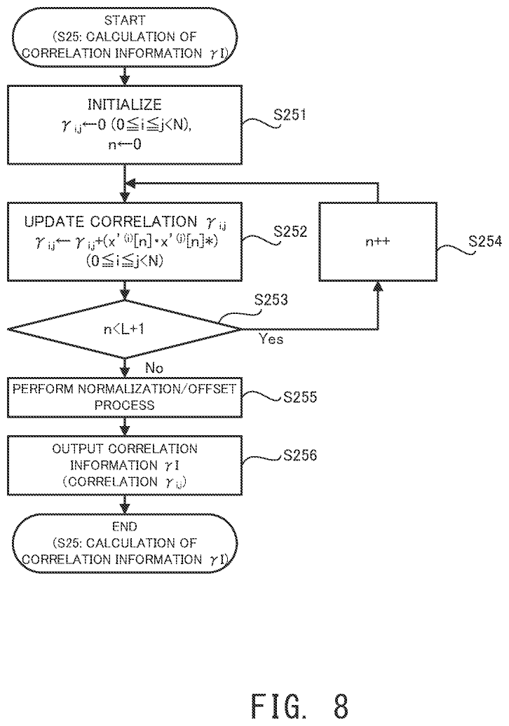

In the communication state detection unit 224, functional blocks for generating the correlation information γI may be realized or implemented. FIG. 3 illustrates an example of the functional blocks realized or implemented in the communication state detection unit 224 to generate the correlation information γI. As illustrated in FIG. 3, a correlation calculation unit 2241 and a normalization/offset processing unit 2242 may be realized or implemented in the communication state detection unit 224. Each of operations of the correlation calculation unit 2241 and the normalization/offset processing unit 2242 will be described in detail later with reference to FIG. 8 or the like, but an outline thereof will be briefly described here. The correlation calculation unit 2241 calculates the correlation γ_{i,j}. The normalization/offset processing unit 2242 performs a predetermined normalization/offset process, a type of which is determined on the basis of a type of the MIMO equalization process, on the correlation γ_{i,j} calculated by the correlation calculation unit 2241. As a result, the normalization/offset processing unit 2242 outputs the correlation information γI including the correlation γ_{i,j} on which the normalization/offset process is performed.

Back in FIG. 2 again, the phase control information generation unit 225 generates phase control information ΔΦ indicating a relationship between each of phases of a plurality of MIMO transmission signals s described in detail later and the communication capacity that is an amount of information that is transmittable to the reception apparatus 2 from the transmission apparatus 1, on the basis of the correlation information γI (the correlation γ_{i,j}) generated by the communication state detection unit 224.

The plurality of MIMO transmission signals s are signals generated by the transmission apparatus 1 to generate the wireless transmission signals tx⁽⁰⁾ to tx^{(N-1)}. Specifically, as described in detail later with reference to FIG. 5 or the like, the transmission apparatus 1 performs a Quadrature Amplitude Modulation (QAM) conversion process or the like on N input signals In⁽⁰⁾ to In^{(N-1)} generated from information to be transmitted to the reception apparatus 2 from the transmission apparatus 1, thereby to generate N transmission signals x⁽⁰⁾ to x^{(N-1)}. Specifically, the transmission apparatus 1 performs the QAM conversion process or the like on N input signals In⁽⁰⁾[n] to In^{(N-1)}[n] generated from the information to be transmitted to the reception apparatus 2 from the transmission apparatus 1 at the time n, thereby to generate N transmission signals x⁽⁰⁾[n] to x^{(N-1)}[n]. Furthermore, the transmission apparatus 1 performs a signal synthesis process or the like on the N transmission signals x⁽⁰⁾ to x^{(N-1)}, thereby to generate N MIMO transmission signals s⁽⁰⁾ to s^{(N-1)} as the plurality of MIMO transmission signals s. Specifically, the transmission apparatus 1 performs the signal synthesis process or the like on the N transmission signals x⁽⁰⁾[n] to x^{(N-1)}[n], thereby to generate N MIMO transmission signals s⁽⁰⁾[n] to s^{(N-1)}[n] as the plurality of MIMO transmission signals s. Furthermore, the transmission apparatus 1 performs a wireless signal process or the like on the N MIMO transmission signals s⁽⁰⁾ to s^{(N-1)}, thereby to generate N wireless transmission signals tx⁽⁰⁾ to tx^{(N-1)}. Specifically, the transmission apparatus 1 performs the wireless signal process or the like on the N MIMO transmission signals s⁽⁰⁾[n] to s^{(N-1)}[n], thereby to generate N wireless transmission signals tx⁽⁰⁾[n] to tx^{(N-1)}[n]. The phase control information generation unit 225 generates the phase control information ΔΦ indicating the relationship between each of phases of the plurality of MIMO transmission signals s⁽⁰⁾ to s^{(N-1)} and the communication capacity. Specifically, the phase control information generation unit 225 generates, as the phase control information ΔΦ, phase control information ΔΦ⁽⁰⁾ indicating the relationship between a phase of the MIMO transmission signal s⁽⁰⁾ and the communication capacity, phase control information ΔΦ⁽¹⁾ indicating the relationship between a phase of the MIMO transmission signal s⁽¹⁾ and the communication capacity, . . . , and phase control information ΔΦ^{(N-1)} indicating the relationship between a phase of the MIMO transmission signal s^{(N-1)} and the communication capacity.

The example embodiment describes an example in which the phase control information generation unit 225 generates, as phase control information ΔΦ^{(k)}, information indicating a change rate of the communication capacity with respect to a shift amount (in other words, a change amount) of a phase of the MIMO transmission signal s⁽¹⁾.

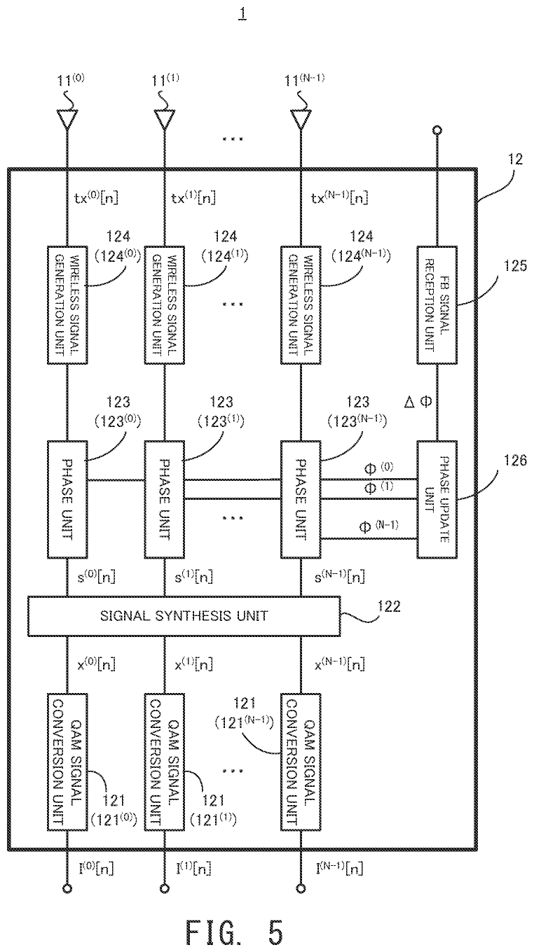

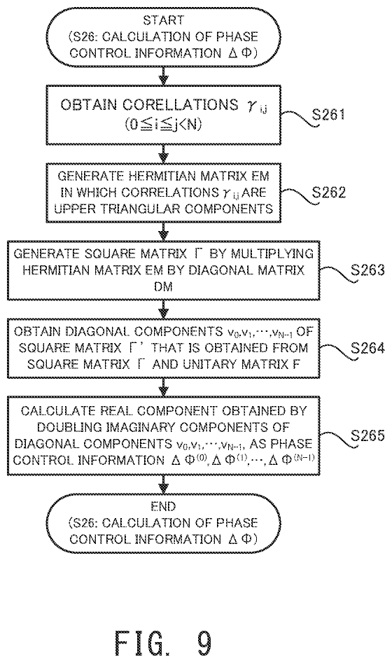

In the phase control information generation unit 225, functional blocks for generating the phase control information ΔΦ may be realized or implemented. FIG. 4 illustrates an example of the functional blocks realized or implemented in the phase control information generation unit 225 to generate the phase control information ΔΦ. As illustrated in FIG. 4, a matrix generation unit 2251 and a unitary transformation unit 2252 may be realized or implemented in the phase control information generating unit 225. Each of operations of the matrix generation unit 2251 and the unitary transformation unit 2252 will be described in detail later with reference to FIG. 9 or the like, but an outline thereof will be briefly described here. The matrix generation unit 2251 generates a square matrix Γ of N rows×N columns, by multiplying a Hermitian matrix EM of N rows×N columns in which N×(N+1)/2 correlations γ_{i,j} indicated by the correlation information γI are upper triangular components, by a predetermined diagonal matrix DM in which the content thereof is determined on the basis of the type of MIMO equalization process. The unitary transformation unit 2252 generates the pieces of phase control information ΔΦ⁽⁰⁾ to ΔΦ^{(N-1)}, on the basis of imaginary components of N diagonal components of a square matrix Γ′ that is obtained by multiplication of a unitary matrix F, the square matrix Γ, and a Hermitian transposed matrix F⁺ of the unitary matrix F, which are used by the transmission apparatus 1 to perform the signal synthesis process.

Back in FIG. 2 again, the feedback signal generation unit 226 generates a feedback signal including the pieces of phase control information ΔΦ⁽⁰⁾ to ΔΦ^{(N-1)}. The feedback signal generation unit 226 transmits the generated feedback signal to the transmission apparatus 1.

### <1-3> Configuration of Transmission Apparatus 1

Next, with reference to FIG. 5, a configuration of the transmission apparatus 1 in the example embodiment (especially, a configuration of the signal processing apparatus 12) will be described. FIG. 5 is a block diagram illustrating logical functional blocks realized or implemented in the signal processing apparatus 12 to perform the transmission operation.

As illustrated in FIG. 5, the signal processing apparatus 12 includes, as the logical functional blocks for performing the transmission operation, a plurality of QAM signal conversion units 121, a signal synthesis unit 122 that is a specific example of the “transmission signal generation unit” in Supplementary Note described later, a plurality of phase units 123 that are a specific example of the “phase adjustment unit” in Supplementary Note described later, a plurality of wireless signal generation units 124, a feedback (FB) signal reception unit 125, and a phase update unit 126 that is a specific example of the “phase calculation unit” in Supplementary Note described later.

FIG. 5 illustrates the logical functional blocks for performing the transmission operation, merely conceptually (in other words, simply). That is, the functional blocks illustrated in FIG. 5 are not necessarily realized or implemented in the signal processing apparatus 12 as they are, and as long as the signal processing apparatus 12 is allowed to perform the operation performed by the functional blocks illustrated in FIG. 5, the configuration of the functional blocks realized or implemented in the signal processing apparatus 12 is not limited to the configuration illustrated in FIG. 5.

The plurality of QAM signal conversion units 121 respectively generate transmission signals x by performing the QAM conversion process or the like on the input signals In generated from the information to be transmitted to the reception apparatus 2 from the transmission apparatus 1. Specifically, the signal processing apparatus 12 includes N QAM signal conversion units 121⁽⁰⁾ to 121^{(N-1)}, as the plurality of QAM signal conversion units 121. The input signals In⁽⁰⁾ to In^{(N-1)} are respectively inputted to the QAM signal conversion units 121⁽⁰⁾ to 121^{(N-1)}. The input signals In⁽⁰⁾ to In^{(N-1)} are respectively N bit sequences generated by dividing the information to be transmitted to the reception apparatus 2 from the transmission apparatus 1, to N bit sequences.

Specifically, the input signals In⁽⁰⁾[n] to In^{(N-1)}[n] are respectively inputted to the QAM signal conversion units 121⁽⁰⁾ to 121^{(N-1)}. The input signals In⁽⁰⁾[n] to In^{(N-1)}[n] are respectively N bit sequences generated by dividing the information to be transmitted to the reception apparatus 2 from the transmission apparatus 1 at the time n, to N bit sequences. A QAM signal conversion unit 121^{(k)} generates the transmission signal x^{(k)}[n] by performing the QAM conversion process or the like on an input signal In^{(k)}[n].

The QAM signal conversion units 121⁽⁰⁾ to 121^{(N-1)} may perform, as the QAM conversion process, a process of converting the N bit sequences that constitute the input signals In⁽⁰⁾[n] to In^{(N-1)}[n], to a sequence of N complex signal points corresponding to quadrature amplitude modulation signals. Consequently, the transmission signals x⁽⁰⁾[n] to x^{(N-1)}[n] corresponding to the sequence of N complex signal points corresponding to the quadrature amplitude modulation signals are generated.

FIG. 5 illustrates an example in which the signal processing apparatus 12 includes the QAM signal conversion units 121⁽⁰⁾ to 121^{(N-1)} that respectively output the transmission signals x⁽⁰⁾[n] to x^{(N-1)}[n]. The signal processing apparatus 12, however, may include a single QAM signal conversion unit 121 and a serial-parallel converter that converts the output of the QAM signal converter 121 to N signal sequences.

The signal synthesis unit 122 performs the signal synthesis process on the N transmission signals x⁽⁰⁾[n] to x^{(N-1)}[n], thereby to generate the N MIMO transmission signals s⁽⁰⁾[n] to s^{(N-1)}[n].

The signal synthesis process may include a process of performing a matrix operation of multiplying the transmission signals x⁽⁰⁾[n] to x^{(N-1)}[n] that are regarded as an N-dimensional vector, by the unitary matrix F of N rows×N columns, and a process of outputting the N-dimensional vector obtained by the matrix operation as the MIMO transmission signals s⁽⁰⁾[n] to s^{(N-1)}[n]. The unitary matrix F is typically a discrete Fourier transform matrix with a length N, but may be a matrix that is different from the discrete Fourier transform matrix with the length N.

The signal synthesis unit 122 may use a unit matrix of N rows×N columns, as the unitary matrix F. In this case, the output of the signal synthesis unit 122 may coincide with the input of the signal synthesis unit 122. That is, the signal synthesis unit 122 may output the transmission signals x⁽⁰⁾[n] to x^{(N-1)}[n] inputted to the signal synthesis unit 122, as the MIMO transmission signals s⁽⁰⁾[n] to s^{(N-1)}[n] as they are.

The plurality of phase units 123 shift (in other words, adjust) the phases of the MIMO transmission signals s, by phase shift amounts p specified by the phase update unit 126. Specifically, the signal processing apparatus 12 includes N phase units 123⁽⁰⁾ to 123^{(N-1)}, as the plurality of phase units 123. A phase unit 123^{(k)} shifts a phase of a MIMO transmission signal s^{(k)}[n], by a phase shift amount φ^{(k)} calculated by the phase update unit 126. Consequently, the phase unit 123^{(k)} outputs the MIMO transmission signal s^{(k)}[n] in which the phase is shifted by the phase shift amount φ^{(k)}.

The plurality of wireless signal generation units 124 respectively generate the plurality of wireless transmission signals tx, from the plurality of MIMO transmission signals s outputted by the plurality of phase units 123. Specifically, the signal processing apparatus 12 includes N wireless signal generation units 124⁽⁰⁾ to 124^{(N-1)}, as the plurality of wireless signal generation units 124. A wireless signal generation unit 124^{(k)} generates a wireless transmission signal tx^{(k)}[n], by performing the wireless signal process on the MIMO transmission signal s^{(k)}[n]. The wireless signaling process may include, for example, at least one of a pulse shaping process, a digital-to-analog conversion process, and an up-conversion process. The wireless transmission signal tx^{(k)}[n] is transmitted to the reception apparatus 2 by using the transmitting antenna element 11.

The feedback signal reception unit 125 receives the feedback signal transmitted by the feedback signal generation unit 226 of the reception apparatus 2. The feedback signal reception unit 125 outputs the received feedback signal to the phase update unit 126. In particular, the feedback signal reception unit 125 outputs the pieces of phase control information ΔΦ⁽⁰⁾ to ΔΦ^{(N-1)} included in the received feedback signal, to the phase update unit 126.

The phase update unit 126 calculates phase shift amounts φ^{(k)} to φ^{(N-1)} respectively used by the phase units 123⁽⁰⁾ to 123^{(N-1)}, on the basis of the pieces of phase control information ΔΦ⁽⁰⁾ to ΔΦ^{(N-1)}.

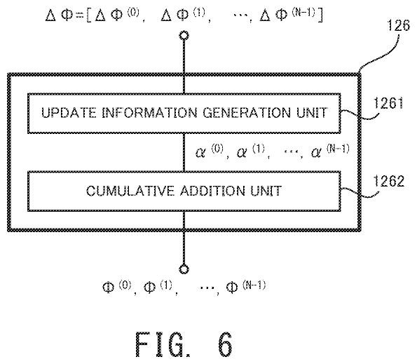

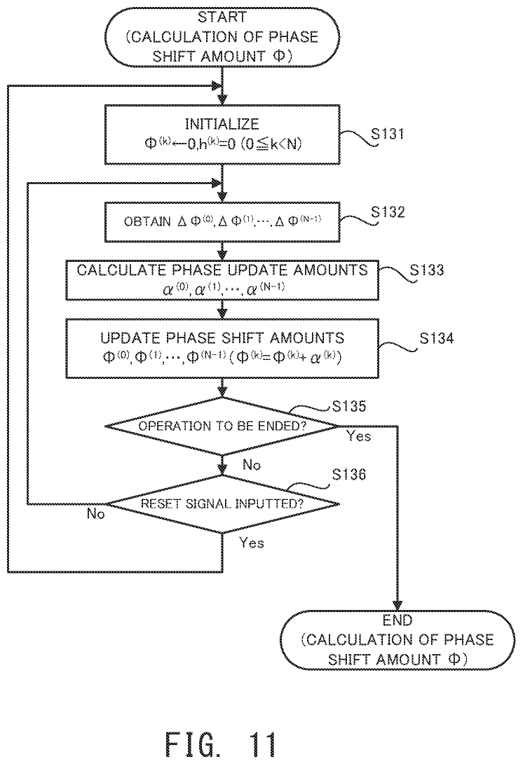

In the phase update unit 126, functional blocks for calculating the phase shift amounts φ⁽⁰⁾ to φ^{(N-1)} may be realized or implemented. FIG. 6 illustrates an example of the functional blocks realized or implemented in the phase update unit 126 to generate the phase control information ΔΦ. As illustrated in FIG. 6, an update information generation unit 1261 and a cumulative addition unit 1262 may be realized or implemented in the phase update unit 126. Each of operations of the update information generation unit 1261 and the cumulative addition unit 1262 will be described in detail later with reference to FIG. 11 or the like, but an outline thereof will be briefly described here. The update information generation unit 1261 calculates a phase update amount α^{(k)} of the MIMO transmission signal s^{(k)}[n], on the basis of the phase control information ΔΦ^{(k)}. The cumulative addition unit 1262 updates the phase shift amount φ^{(k)}, by adding the phase update amount α^{(k)} to the phase shift amount φ^{(k)}. The phase shift amount φ^{(k)} updated on the basis of the phase update amount α^{(k)} is used to shift the phase of the MIMO transmission signal s^{(k)}[n] by the phase unit 123^{(k)}.

### <2> Operation of Wireless Communication System SYS

Next, operation of the wireless communication system SYS according to the example embodiment will be described.

<2-1> Reception Operation performed by Reception Apparatus 2

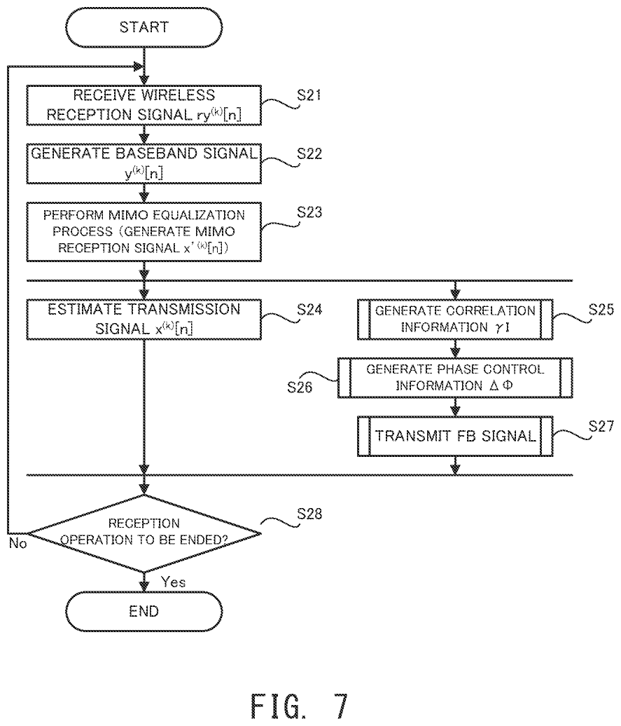

First, with reference to FIG. 7, the reception operation performed by the reception apparatus 2. FIG. 7 is a flowchart illustrating a flow of the reception operation performed by the reception apparatus 2.

As illustrated in FIG. 7, the reception apparatus 2 receives the wireless reception signals ry⁽⁰⁾[n] to ry^{(N-1)}[n], by using the receiving antenna elements 21⁽⁰⁾ to 21^{(N-1)}, respectively (step S21). Then, the baseband signal generation units 221⁽⁰⁾ to 221^{(N-1)} respectively generate the baseband signals y⁽⁰⁾ to y^{(N-1}), from the wireless reception signals ry⁽⁰⁾[n] to ry^{(N-1)}[n] (step S22).

Then, the MIMO equalization processing unit 222 performs the MIMO equalization process on the baseband signals y⁽⁰⁾ to y^{(N-1)} (step S23). Consequently, the MIMO equalization processing unit 222 generates the MIMO reception signals x′⁽⁰⁾[n] to x′^{(N-1)}[n] (step S23).

When the tap coefficient matrix in the MIMO equalization process is W, the MIMO equalization process may include a process of performing a matrix operation shown in Equation 1. A symbol “T” in Equation 1 means a transposed matrix. The following describes an example in which the tap coefficient matrix W is a matrix of N rows×N columns (i.e., the simplest example). A symbol “⋅” in Equation 1 denotes multiplication. The same applies in the following description.

(x′⁽⁰⁾[n],x′⁽¹⁾[n], . . . ,x′^{(N-1)}[n])^{T}=W·(y⁽⁰⁾[n],y⁽¹⁾[n]^{T} [Equation 1]

As described above, the MIMO equalization processing unit 222 may perform at least one of the ZF process and the MMSE process, as the MIMO equalization process. In this instance, the tap coefficient matrix W used in the ZF process may be different from the tap coefficient matrix W used in the MMSE process. For example, when the ZF process is performed as the MIMO equalization process, a matrix shown in Equation 2 may be used as the tap coefficient matrix W. For example, when the MMSE process is performed as the MIMO equalization process, a matrix shown in Equation 3 may be used as the tap coefficient matrix W. A symbol “H” in Equations 2 and 3 is a matrix of N rows×N columns representing a signal change in a signal path from the QAM signal conversion unit 121 of the transmission apparatus 1 to the MIMO equalization processing unit 222. A symbol “+” in Equations 2 and 3 denotes a Hermitian transposed matrix (i.e., a conjugate transposed matrix). A symbol “P” in Equation 3 denotes a signal power (i.e., a transmission signal power) per signal of the wireless transmission signals tx⁽⁰⁾[n] to tx^{(N-1)}[n]. A symbol “σ” in Equation 3 denotes noise variance. A symbol “I” in Equation 3 denotes a unit matrix of N rows×N columns.

$$W = {( {H}^{+} H )}^{- 1} {H}^{+} \qquad [ Equation 2 ]$$

$$W = {{H}^{+} ( H {H}^{+} + \frac{{σ}^{2}}{P} I )}^{- 1} \qquad [ Equation 3 ]$$

Then, the signal determination units 223⁽⁰⁾ to 223^{(N-1)} respectively estimate the transmission signals x⁽⁰⁾[n] to x^{(N-1)}[n] from the MIMO reception signals x′⁽⁰⁾ to x′^{(N-1)} (step S24).

In parallel with, or before or after the operation in the step S24, the communication state detection unit 224 generates the correlation information γI indicating the correlation among the MIMO reception signals x′⁽⁰⁾ to x′^{(N-1)} (step S25). Specifically, the communication state detection unit 224 generates the correlation information γI on the basis of the MIMO reception signals x′⁽⁰⁾[n] to x′^{(N-1)}[n] at the time n in which 0≤n<L is satisfied.

Now, with reference to FIG. 8, an operation of generating the correlation information γI in the step S25 in FIG. 7 will be described in detail. FIG. 8 is a flowchart illustrating a flow of the operations of generating the correlation information γI in the step S25 in FIG. 7.

As illustrated in FIG. 8, the communication state detection unit 224 initializes a variable n indicating the time, and the correlation γ_{i,j} included in the correlation information γI (step S251). Specifically, the communication state detection unit 224 initializes the variable n such that the variable n is zero. Furthermore, the communication state detection unit 224 repeats the operation of initializing the correlation γ_{i,j} such that the correlation γ_{i,j} is zero, while changing the combination pattern of the variable i and the variable j.

Then, the communication state detection unit 224 (especially, the correlation calculation unit 2241) repeats an operation of updating the correlation γ_{i,j} using Equation 4, while changing the combination pattern of the variable i and the variable j (step S252). A symbol “*” in Equation 4 denotes complex conjugate. Specifically, the correlation calculation unit 2241 repeats an operation of adding a multiplication result of a MIMO reception signal x′⁽ⁱ⁾[n] and the complex conjugate of a MIMO reception signal x′^{(j)}[n], to the correlation γ_{i,j}, while changing the combination pattern of the variable i and the variable j. A symbol “←” in Equation 4 denotes an operation of substituting the right side into the left side. Even in the following description, the symbol “←” denotes the operation of substituting the right side into the left side.

γ_{i,j}←γ_{i,j}+(x′⁽ⁱ⁾[n]·x′^{(j)}[n]*) [Equation 4]

The correlation calculation unit 2241 repeats the step S252 by incrementing the variable n indicating the time by 1, while it is determined that the variable n is less than L+1 (step S253 to step S254). That is, the correlation calculation unit 2241 repeats the step S252, L times, while incrementing the variable n by 1. Consequently, the correlation γ_{i,j} at a time when it is determined that the variable n indicating the time is not less than L+1 (i.e., is greater than or equal to L+1) indicates a correlation between MIMO reception signals x′⁽ⁱ⁾[0], x′⁽ⁱ⁾[1], . . . , and x′⁽ⁱ⁾[L−1] and MIMO reception signals x′^{(j)}[0], x′^{(j)}[1], . . . , and x′⁽ⁱ⁾[L−1].

Then, the communication state detection unit 224 (especially, the normalization/offset processing unit 2242) performs the predetermined normalization/offset process on the correlation γ_{i,j} (step S255). As described above, the type of the normalization/offset process performed in the step S255 is determined on the basis of the type of the MIMO equalization process. That is, the type of normalization/offset process performed in the step S255 may vary on the basis of the type of the MIMO equalization process.

For example, when the MMSE process is performed as the MIMO equalization process, the normalization/offset processing unit 2242 may perform a process shown in Equation 5, as the normalization/offset process. A symbol “L” in Equation 5 denotes a length of the signal sequences of the MIMO reception signals x′⁽⁰⁾[n] to x′^{(N-1)}[n]. A symbol “P” in Equation 5 denotes, as in the symbol “P” in Equation 3, a signal power per signal of the wireless transmission signals tx⁽⁰⁾[n] to tx^{(N-1)}[n]. In this instance, the normalization/offset process shown in Equation 5 includes a processing of normalizing the correlation γ_{i,j} by using a multiplication result of the length L of the signal sequences and the signal power P.

$${γ}_{i , j} ← \frac{{γ}_{i , j}}{P L} \qquad [ Equation 5 ]$$

For example, when the ZF process is performed as the MIMO equalization process, the normalization/offset processing unit 2242 may perform a process shown in Equation 6, as the normalization/offset process. A symbol “δ(i, j)” in Equation 6 denotes 1 when the variable i and the variable j are the same, and denotes zero when the variable i and the variable j are not the same. In this instance, the normalization/offset process shown in Equation 5 includes a process of normalizing the correlation γ_{i,j} by using the multiplication result of the length L of the signal sequences and the signal power P, and a process of offsetting a normalization result by an offset value indicated by the symbol δ(i, j).

$${γ}_{i , j} ← \frac{{γ}_{i , j}}{P L} - δ ( i , j ) \qquad [ Equation 6 ]$$

Consequently, the communication state detection unit 224 outputs the correlation information γI indicating the correlation γ_{i,j} on which the normalization/offset process is performed, to the phase control information generation unit 225 (step S256).

Bak in FIG. 7 again, then, the phase control information generation unit 225 generates the phase control information ΔΦ, on the basis of the correlation information γI (the correlation γ_{i,j}) generated in the step S25 (step S26).

Now, with reference to FIG. 9, an operation of generating the phase control information ΔΦ in the step S26 in FIG. 7 will be described in detail. FIG. 9 is a flowchart illustrating a flow of the operation of generating the phase control information ΔΦ in the S26 in FIG. 7.

As illustrated in FIG. 9, the phase control information generation unit 225 (especially, the matrix generation unit 2251) obtains the N×(N+1)/2 correlations γ_{i,j} (step S261).

Then, the matrix generation unit 2251 generates the Hermitian matrix EM of N rows×N columns in which N×(N+1)/2 correlations γ_{i,j} obtained in the step S261 are upper triangular components (step S262). That is, the matrix generation unit 2251 generates the Hermitian matrix EM such that a matrix component EMᵢⱼ of an i-th row and a j-th column is γ_{i,j}. Lower triangular components of the Hermitian matrix EM may be complex conjugates of N×(N+1)/2 correlations γ_{i,j}. That is, the matrix generation unit 2251 may generate the Hermitian matrix EM such that a matrix component EM_{j,i} of a j-th row and an i-th column is a complex conjugate of γ_{i,j}.

Then, the matrix generation unit 2251 generates a square matrix Γ of N rows×N columns by multiplying the Hermitian matrix EM generated in the step S262 by the predetermined diagonal matrix DM (step S263). Specifically, the matrix generation unit 2251 generates the square matrix Γ by multiplying the Hermitian matrix EM by the diagonal matrix DM from the left side of the Hermitian matrix EM. That is, the matrix generation unit 2251 generates the square matrix Γ by using an Equation of Γ=DM×EM.

A type of the diagonal matrix DM used in the step S263 is determined on the basis of the type of the MIMO equalization process. That is, the type of the diagonal matrix DM used in the step S263 may vary on the basis of the type of the MIMO equalization process.

For example, when the MMSE process is performed as the MIMO equalization process, the matrix generation unit 2251 may use a diagonal matrix in which a diagonal component of the j-th row and the j-th column is 1/(1−γⱼⱼ), as the diagonal matrix DM. In this case, a matrix component Γ_{i,j} of the i-th row and the j-th column of the square matrix Γ is γ_{i,j}/(1-γⱼⱼ).

For example, when the ZF process is performed as the MIMO equalization process, the matrix generation unit 2251 may use a diagonal matrix in which the diagonal component of the j-th row and the j-th column is −1/(γⱼⱼ(1+γⱼⱼ)), as the diagonal matrix DM. In this case, the matrix component Γi,j of the i-th row and the j-th column of the square matrix Γ is −γ_{i,j}/(γⱼⱼ(1+γⱼⱼ)).

Then, the phase control information generation unit 225 (especially, the unitary transformation unit 2252) generates the square matrix Γ′ that is obtained by multiplication of the unitary matrix F, the square matrix Γ, and the Hermitian transposed matrix F⁺ of the unitary matrix F, and it obtains N diagonal components v₀, v₁, . . . , and v_{N-1} of the square matrix Γ′ (step S264). Specifically, the unitary transformation unit 2252 generates the square matrix Γ′ of N columns x N rows, by multiplying the square matrix Γ by the unitary matrix F from the left side of the square matrix Γ and by multiplying it by the Hermitian transposed matrix F⁺ from the right side of the square matrix Γ. That is, the unitary transformation unit 2252 generates the square matrix Γ′ by using an Equation of Γ′=F×Γ×F⁺. Then, the unitary transformation unit 2252 extracts the N diagonal components v₀, v₁, . . . , and v_{N-1} from the square matrix Γ′.

The N diagonal components v₀, v₁, . . . , and v_{N-1} obtained in the step S264 are complex numbers. In this instance, the unitary transformation unit 2252 calculates a real component obtained by doubling the imaginary component of a diagonal component vₖ, as the phase control information ΔΦ^{(k)} (step S265). That is, the unitary transformation unit 2252 calculates the real component obtained by doubling the imaginary component of the diagonal component v₀ as the phase control information ΔΦ⁽⁰⁾, calculates the real component obtained by doubling the imaginary component of the diagonal component v₁ as the phase control information ΔΦ⁽¹⁾, . . . , and calculates the real component obtained by doubling the imaginary component of the diagonal component v_{N-1} as the phase control information ΔΦ^{(N-1)}.

The phase control information ΔΦ^{(N-1)} calculated in this manner indicates a relationship between the phase shift amount φ^{(k)} used by the phase unit 123^{(k)} of the transmission apparatus 1 illustrated in FIG. 5 and the communication capacity. Specifically, the phase control information ΔΦ^{(k)} indicates the change rate of the communication capacity with respect to the phase shift amount φ^{(k)}. When the phase control information ΔΦ^{(k)} is positive, it is assumed that the communication capacity is increased by increasing the phase shift amount φ^{(k)}. On the other hand, when the phase control information ΔΦ^{(k)} is negative, it is assumed that the communication capacity is increased by reducing the phase shift amount φ^{(k)}.

Back in FIG. 7 again, the feedback signal generation unit 226 generates the feedback signal including the pieces of phase control information ΔΦ⁽⁰⁾ to ΔΦ^{(N-1)} generated in the step S26 (step S27). Then, the feedback signal generation unit 226 transmits the generated feedback signal to the transmission apparatus 1 (step S27).

The above operation is repeated until the reception operation is ended (step S28).

<2-2> Transmission Operation performed by Transmission Apparatus 1

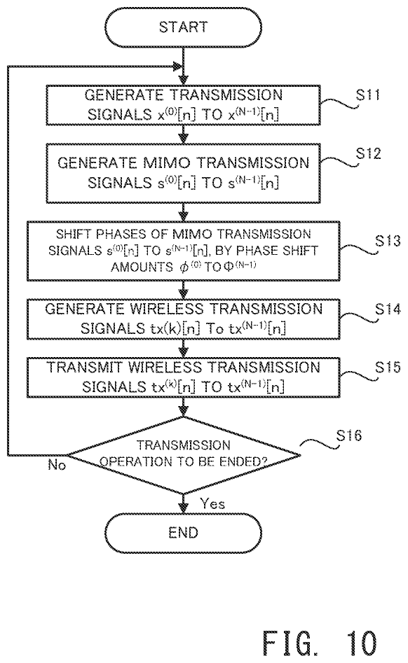

Next, the transmission operation performed by the transmission apparatus 1 will be described with reference to FIG. 10. FIG. 10 is a flowchart illustrating a flow of the transmission operation performed by the transmission apparatus 1.

As illustrated in FIG. 10, the QAM signal conversion units 121⁽⁰⁾ to 121^{(N-1)} respectively generate the transmission signals x⁽⁰⁾[n] to x^{(N-1)}[n], from the input signals In⁽⁰⁾[n] to In^{N-1)}[n] (step S11).

Then, the signal synthesis unit 122 performs the signal synthesis process on the transmission signals x⁽⁰⁾[n] to x^{(N-1)}[n], thereby to generate the MIMO transmission signals s⁽⁰⁾[n] to s^{(N-1})[n] (step S12). Specifically, the signal synthesis unit 122 performs the signal synthesis process on the transmission signals x⁽⁰⁾[n] to x^{(N-1)}[n] by using the unitary matrix Γ, thereby to generate the MIMO transmission signals s⁽⁰⁾[n] to s^{(N-1)}[n]. In this instance, the signal synthesis unit 122 may generate the MIMO transmission signals s⁽⁰⁾[n] to s^{(N-1)}[n] by performing the signal synthesis process shown in Equation 7. The unitary matrix Γ used by the signal synthesis unit 122 to generate the MIMO transmission signals s⁽⁰⁾[n] to s^{(N-1)}[n] is the same as the unitary matrix Γ used by the phase control information generation unit 225 of the reception apparatus 2 to generate the pieces of phase control information ΔΦ⁽⁰⁾ to ΔΦ^{(N-1)}.

(s⁽⁰⁾[n],s⁽¹⁾[n], . . . ,s^{(N-1)}[n])^{T}=F·(x⁽⁰⁾[n],x⁽¹⁾[n], . . . ,x^{(N-1)}[n])^{T} [Equation 7]

Then, the phase units phase units 123⁽⁰⁾ to 123^{(N-1)} respectively shift the phases of the MIMO transmission signals s⁽⁰⁾[n] to s^{(N-1)}[n] generated in the step S12, by the phase shift amounts φ⁽⁰⁾ to φ^{(N-1)} (step S13). In this instance, the phase units 123⁽⁰⁾ to 123^{(N-1)} output N signals shown in Equation 8 as the MIMO transmission signals s⁽⁰⁾[n] to s^{(N-1})[n] in which the phases thereof are desirably shifted by the phase shift amounts φ⁽⁰⁾ to φ^{(N-1)}.

e^{jΦ}^{⁽⁰⁾}s⁽⁰⁾,e^{jΦ}^{⁽¹⁾}(s)⁽¹⁾[n], . . . ,e^{jΦ}^{^{(N−1)}}s^{(N-1)}[n] [Equation 8]

The phase shift amounts φ⁽⁰⁾ to φ^{(N-1)} used in the step S13 are calculated by the phase update unit 126. Here, with reference to FIG. 11, an operation of calculating the phase shift amounts φ⁽⁰⁾ to φ^{(N-1)} will be described in detail. FIG. 11 is a flowchart illustrating a flow of the operation of calculating the phase shift amounts φ⁽⁰⁾ to φ^{(N-1)}.

As illustrated in FIG. 11, the phase update unit 126 initializes the phase shift amounts φ⁽⁰⁾ to φ^{(N-1)} (step S131). Specifically, the phase update unit 126 initializes the phase shift amounts φ⁽⁰⁾ to φ^{(N-1)} such that each of the initializes the phase shift amounts φ⁽⁰⁾ to φ^{(N-1)} is zero. Furthermore, the phase update unit 126 initializes internal variables h₍₀₎ to h^{(N-1)} used to calculate the phase shift amounts φ⁽⁰⁾ to φ^{(h-1)} (step S131). Specifically, the phase update unit 126 initializes the internal variables h⁽⁰⁾ to h^{(N-1)} such that each of the internal variables h⁽⁰⁾ to h^{(N-1)} is zero.

Then, the phase update unit 126 (especially, the update information generation unit 1261) obtains the pieces of phase control information ΔΦ⁽⁰⁾ to ΔΦ^{(N-1)} included in the feedback signal transmitted from the reception apparatus 2 (step S132).

Then, the update information generation unit 1261 calculates a phase update amount α⁽⁰⁾ of the MIMO transmission signal s⁽⁰⁾[n] to a phase update amount α^{(N-1)} of the MIMO transmission signal s^{(N-1})[n], on the basis of the pieces of phase control information ΔΦ⁽⁰⁾ to ΔΦ^{(N-1)} obtained in the step S132 (step S263). Specifically, first, the update information generation unit 1261 updates the internal variables h⁽⁰⁾ to h^{(N-1}) by using Equation 9. A symbol “ρ” in Equation 9 is an arbitrarily settable hyperparameter. Then, the update information generation unit 1261 updates the phase update amounts α⁽⁰⁾ to α^{(N-1}) by using Equation 10. A symbol “η” in Equation 10 is an arbitrarily settable hyperparameter. As shown in Equation 9 and Equation 10, an operation of updating the phase update amounts α⁽⁰⁾ to α^{(N-1)} may be the same as an operation using a learning algorithm referred to as RMSProp.

$${h}^{( k )} ← ρ {h}^{( k )} + ( 1 - ρ ) {( Δ {Φ}^{( k )} )}^{2} \qquad [ Equation 9 ]$$

$${α}^{( k )} ← \frac{η}{\sqrt{{h}^{( k )}}} Δ {Φ}^{( k )} \qquad [ Equation 10 ]$$

Then, the phase update unit 126 (especially, the cumulative addition unit 1262) updates the phase shift amounts φ⁽⁰⁾ to φ^{(N-1)}, by respectively adding the phase update amounts α⁽⁰⁾ to α^{(N-1)} calculated in step S133 to the phase shift amounts φ⁽⁰⁾ to φ^{(N-1)} (step S134). That is, the cumulative addition unit 1262 updates the phase update amount φ^{(k)}, by using an equation of Phase shift amount φ^{(k)}=Phase shift amount φ^{(k)}+Phase update amount α^{(k)}.

As described above, the phase control information Δφ^{(k)} indicates the change rate of the communication capacity with respect to the phase shift amount φ^{(k)}. As described above, when the phase control information ΔΦ^{(k)} is positive, it is assumed that the communication capacity is increased by increasing the phase shift amount φ^{(k)}. As is clear from Equation 9 and Equation 10, when the phase control information ΔΦ^{(k)} is positive, the positive phase update amount α^{(k)} is calculated. Therefore, the phase shift amount φ^{(k)} is increased by adding the phase update amount α^{(k)} to the phase shift amount φ^{(k)}. As a result, the communication capacity is expectedly increased by updating (increasing) the phase shift amount φ^{(k)}. On the other hand, when the phase control information ΔΦ^{(k)} is negative, it is assumed that the communication capacity is increased by reducing the phase shift amount φ^{(k)}. As is clear from Equation 9 and Equation 10, when the phase control information ΔΦ^{(k)} is negative, the negative phase update amount α^{(k)} is calculated. Therefore, the phase shift amount φ^{(k)} is reduced by adding the phase update amount α^{(k)} to the phase shift amount φ^{(k)}. As a result, the communication capacity is expectedly increased by updating (reducing) the phase shift amount φ^{(k)}.

As described above, in the example embodiment, the phases of the MIMO transmission signals s⁽⁰⁾[n] to s^{(N-1)}[n] are shifted to increase the communication capacity of the wireless communication system SYS. Here, the phase shift amounts φ⁽⁰⁾ to φ^{(N-1)} indicating the shift amounts of the phases of the MIMO transmission signals s⁽⁰⁾[n] to s^{(N-1)}[n] are calculated on the basis of the correlation information γI indicating the correlation γ_{i,j} among the MIMO reception signals x′⁽⁰⁾ to x′^{(N-1}). In this instance, it may be considered that the correlation information γI indicating the correlation among the MIMO reception signals x′⁽⁰⁾ to x′^{(N-1)} includes information about a change in the communication capacity. In other words, it may be considered that the wireless communication system SYS detects the changes in the communication capacity on the basis of the correlation information γI indicating the correlation γ_{i,j} among the MIMO reception signals x′⁽⁰⁾ to x′^{(N-1)}, and shifts the phases of the MIMO transmission signals s⁽⁰⁾[n] to s^{(N-1)}[n] to and prevent a reduction in the communication capacity. As described above, considering that the change in the communication capacity is caused by the change in the relative positional relationship between the plurality of transmitting antenna elements 11 and the plurality of receiving antenna elements 21, it may be considered that the wireless communication system SYS detects the change in the communication capacity caused by the change in the relative positional relationship between the plurality of transmitting antenna elements 11 and the plurality of receiving antenna elements 21 on the basis of the correlation information γI indicating the correlation γ_{i,j} among the MIMO reception signals x′⁽⁰⁾ to x′^{(N-1}), and shifts the phases of the MIMO transmission signals s⁽⁰⁾[n] to s^{(N-1)}[n] to and prevent a reduction in the communication capacity. Consequently, the wireless communication system SYS is allowed to properly reduce an influence on the communication capacity caused by the change in the relative positional relationship between the plurality of transmitting antenna elements 11 and the plurality of receiving antenna elements 21.

The phase update unit 126 repeats the step S131 to the step S134 until it is determined that the operation illustrated in FIG. 11 is to be ended (step S135). At this time, when a reset signal for requesting the initialization of the phase shift amounts φ⁽⁰⁾ to φ^{(N-1)} and the internal variables h⁽⁰⁾ to h^{(N-1)} is inputted to the phase update unit 126 (step S136: Yes), the phase update unit 126 performs an initialization operation in the step S131, and then performs the step S132 to the step S134. On the other hand, when the reset signal is not inputted (step S136: No), the phase update unit 126 performs the step S132 to the step S134 without performing the initialization operation in the step S131. Therefore, the phase update unit 126 updates the phase shift amount φ^{(k)} by continuing to cumulatively adding the phase update amount α^{(k)} to the phase shift amount φ^{(k)} until the reset signal is inputted.

Back in FIG. 10 again, then, the wireless signal generation units 124⁽⁰⁾ to 124^{(N-1)} respectively perform the wireless signal process on the MIMO transmission signals s⁽⁰⁾[n] to s^{(N-1)}[n] outputted from the phase units 123⁽⁰⁾ to 123^{(N-1)}, thereby to generate the wireless transmission signals tx⁽⁰⁾[n] to tx^{(N-1)}[n] (step S14). The wireless transmission signals tx⁽⁰⁾[n] to tx^{(N-1)}[n] are transmitted to the reception apparatus 2 by using the transmitting antenna elements 11⁽⁰⁾ to 11^{(N-1)}, respectively (step S15).

### <3> Technical Effect of Wireless Communication System SYS

As described above, the wireless communication system SYS is configured to shift the phases of the MIMO transmission signals s⁽⁰⁾[n] to s^{(N-1)}[n] to increase the communication capacity of the wireless communication system SYS. Therefore, the wireless communication system SYS is allowed to properly reduce the influence on the communication capacity caused by the change in the relative positional relationship between the plurality of transmitting antenna elements 11 and the plurality of receiving antenna elements 21. Especially in the example embodiment, the wireless communication system SYS is allowed to properly reduce the influence on the communication capacity caused by the change in the relative positional relationship between the plurality of transmitting antenna elements 11 and the plurality of receiving antenna elements 21, without depending on an arrangement pattern of the plurality of transmitting antenna elements 11 and the plurality of receiving antenna elements 21.

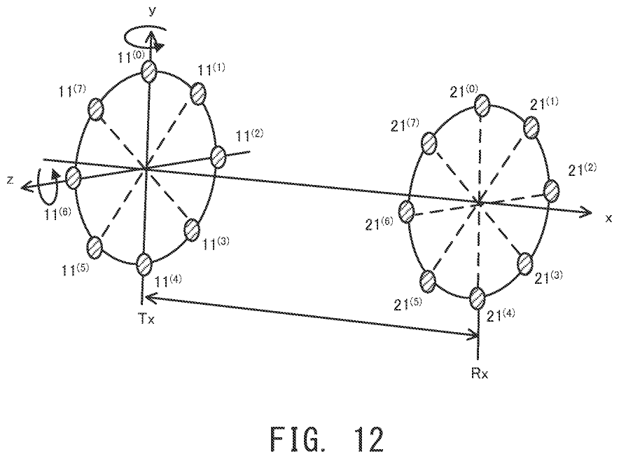

Here, as a specific example of the technical effect of the wireless communication system SYS, as illustrated in FIG. 12, a technical effect realized in the following cases will be described: (i) the transmission apparatus 1 includes eight transmitting antenna elements 11 arranged on the circumference; (ii) the reception apparatus 2 includes eight receiving antenna elements 21 arranged on the circumference, and (iii) each of the signal synthesis unit 122 of the transmission apparatus 1 and the phase control information generation unit 225 of the reception apparatus 2 uses a discrete Fourier transform matrix with a length N of 8, as the unitary matrix Γ.

Here, when the relative positional relationship between the plurality of transmitting antenna elements 11 and the plurality of receiving antenna elements 21 is an ideal positional relationship, it is not necessary to shift the MIMO transmission signals s⁽⁰⁾[n] to s^{(N-1)}[n] by using the phase units 123. In this instance, the phase update unit 126 calculates the phase shift amounts φ⁽⁰⁾ to φ⁽⁷⁾ that are zero.

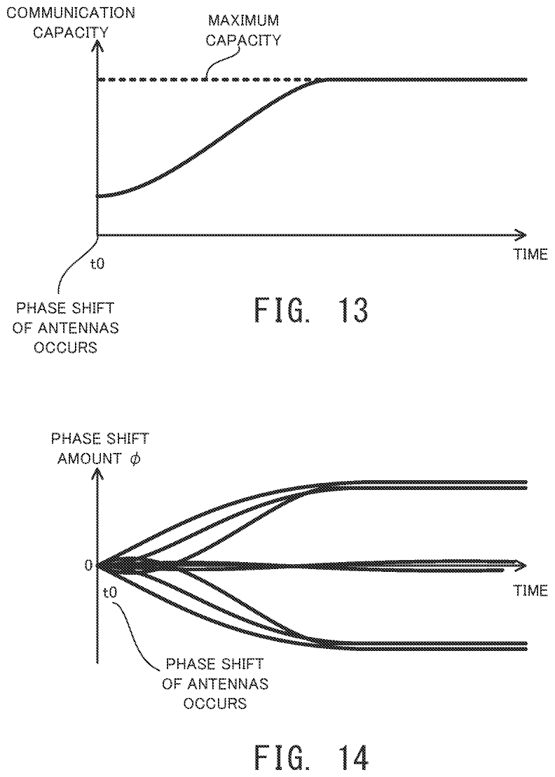

On the other hand, when the relative positional relationship between the plurality of transmitting antenna elements 11 and the plurality of receiving antenna elements 21 is different from the ideal positional relationship, the communication capacity is reduced. For example, FIG. 13 illustrates a time course in the communication capacity when the relative positional relationship between the plurality of transmitting antenna elements 11 and the plurality of receiving antenna elements 21 is shifted by several degrees along a y-axis direction and a z-axis direction with respect to the ideal positional relationship. As illustrated in FIG. 13, when the relative positional relationship between the plurality of transmitting antenna elements 11 and the plurality of receiving antenna elements 21 is changed at a time t0, the communication capacity is reduced immediately after that, but the communication capacity is recovered due to the shifted phase of the MIMO transmission signals s⁽¹⁾[n] to s⁽⁷⁾[n] described above.

Furthermore, FIG. 14 illustrates a time course in that the phase shift amounts φ⁽⁰⁾ to φ⁽⁷⁾ used by eight phase units 123⁽⁰⁾ to 123⁽⁷⁾ in a situation where the communication capacity is changed as illustrated in FIG. 13. In the example illustrated in FIG. 14, three of the eight phase shifter units 123⁽⁰⁾ to 123⁽⁷⁾ shift the phase to advance the phase, other three of the eight phase shifter units 123⁽⁰⁾ to 123⁽⁷⁾ shift the phase to delay the phase, and the remaining two of the eight phase shifter units 123⁽⁰⁾ to 123⁽⁷⁾ hardly shift the phase. As illustrated in FIG. 14, it is clear that the phase shift amounts φ⁽⁰⁾ to φ⁽⁷⁾ are updated with time, and consequently, the communication capacity is recovered.

FIG. 13 and FIG. 14 illustrate an example in which, after the relative positional relationship between the plurality of transmitting antenna elements 11 and the plurality of receiving antenna elements 21 is changed at the time t0, the relative positional relationship between the plurality of transmitting antenna elements 11 and the plurality of receiving antenna elements 21 is no longer changed. The above effect, however, can be enjoyed even when the relative positional relationship between the plurality of transmitting antenna elements 11 and the plurality of receiving antenna elements 21 is further changed even after the relative positional relationship between the plurality of transmitting antenna elements 11 and the plurality of receiving antenna elements 21 is changed at the time t0.

### <4> Supplementary Notes

With respect to the example embodiment described above, the following Supplementary Notes are further disclosed.

### [Supplementary Note 1]

A wireless communication system including:
a transmission apparatus that generates a plurality of synthesized transmission signals by performing a signal synthesis process on a plurality of transmission signals, and that transmits a wireless signal including a plurality of wireless transmission signals generated from the plurality of synthesized transmission signals, by using a plurality of transmitting antenna elements; and
a reception apparatus that receives the wireless signal transmitted by the transmission apparatus, as a plurality of wireless reception signals, by using a plurality of receiving antenna elements,
the reception apparatus including:
a reception signal generation unit that generates a plurality of separated reception signals by performing a signal separation process on the plurality of wireless reception signals;
a correlation information generation unit that generates correlation information indicating a correlation among the plurality of separated reception signals;
a phase control information generation unit that generates phase control information indicating a relationship between a phase of each of the plurality of synthesized transmission signals and a communication capacity, on the basis of the correlation information; and
a transmission unit that transmits the phase control information to the transmission apparatus,
the transmission apparatus including:
a reception unit that receives the phase control information transmitted by the transmission unit;
a transmission signal generation unit that generates the plurality of synthesized transmission signals by performing the signal synthesis process on the plurality of transmission signals;
a phase calculation unit that calculates a phase shift amount indicating a shift amount of the phase of each of the plurality of synthesized transmission signals, on the basis of the phase control information received by the reception unit; and
a phase adjustment unit that adjusts the phase of each of the plurality of synthesized transmission signals, by the phase shift amount calculated by the phase calculation unit.

### [Supplementary Note 2]

The wireless communication system according to Supplementary Note 1, wherein
the correlation information generation unit
calculates the correlation including
a cross-correlation between a first separated reception signal of the plurality of separated reception signals and a complex conjugate of a second separated reception signal of the plurality of separated reception signals that is different from the first separated reception signal, and an autocorrelation between the first separated reception signal and a complex conjugate of the first separated reception signal, and
normalizes the correlation by using a transmission signal power, thereby to generate the correlation information indicating the normalized correlation.

### [Supplementary Note 3]

The wireless communication system according to Supplementary Note 1 or 2, wherein
the phase control information generation unit
generates a first square matrix with the correlation information as a matrix component, and
generates the phase control information by using imaginary components of diagonal components of a second square matrix that is obtained by multiplication of a unitary matrix used in the signal synthesis process, the first square matrix, and a Hermitian transposed matrix of the unitary matrix.

### [Supplementary Note 4]

The wireless communication system according to any one of Supplementary Notes 1 to 3, wherein
the phase calculation unit
calculates an update amount of the phase shift amount, on the basis of the phase control information received by the reception unit, and
calculates the phase shift amount by cumulatively adding the update amount to the phase shift amount to update the phase shift amount.

### [Supplementary Note 5]

The wireless communication system according to any one of Supplementary Notes 1 to 4, wherein
the plurality of transmitting antenna elements are N transmitting antenna elements arranged on a circumference of a first circle (where N is a variable indicating an integer of 2 or more),
the plurality of receiving antenna elements are N receiving antenna elements arranged on a circumference of a second circle, and
the signal synthesis unit performs the signal synthesis process by using a unitary matrix that is a discrete Fourier transform matrix with a length N.

### [Supplementary Note 6]

A wireless communication method using:
a transmission apparatus that generates a plurality of synthesized transmission signals by performing a signal synthesis process on a plurality of transmission signals, and that transmits a wireless signal including a plurality of wireless transmission signals generated from the plurality of synthesized transmission signals, by using a plurality of transmitting antenna elements; and
a reception apparatus that receives the wireless signal transmitted by the transmission apparatus, as a plurality of wireless reception signals, by using a plurality of receiving antenna elements,
the wireless communication method including:
generating a plurality of separated reception signals by performing a signal separation process on the plurality of wireless reception signals;
generating correlation information indicating a correlation among the plurality of separated reception signals;
generating phase control information indicating a relationship between a phase of each of the plurality of synthesized transmission signals and a communication capacity, on the basis of the correlation information;
generating the plurality of synthesized transmission signals by performing the signal synthesis process on the plurality of transmission signals;
calculating a phase shift amount indicating a shift amount of the phase of each of the plurality of synthesized transmission signals, on the basis of the phase control information received by the reception unit; and
adjusting the phase of each of the plurality of synthesized transmission signals, by the phase shift amount calculated by the phase calculation unit.

### [Supplementary Note 7]

A non-transitory recording medium on which a computer program that allows a computer to execute a wireless communication method is recorded,
the wireless communication method using:
a transmission apparatus that generates a plurality of synthesized transmission signals by performing a signal synthesis process on a plurality of transmission signals, and that transmits a wireless signal including a plurality of wireless transmission signals generated from the plurality of synthesized transmission signals, by using a plurality of transmitting antenna elements; and
a reception apparatus that receives the wireless signal transmitted by the transmission apparatus, as a plurality of wireless reception signals, by using a plurality of receiving antenna elements,
the wireless communication method including:
generating a plurality of separated reception signals by performing a signal separation process on the plurality of wireless reception signals;
generating correlation information indicating a correlation among the plurality of separated reception signals;
generating phase control information indicating a relationship between a phase of each of the plurality of synthesized transmission signals and a communication capacity, on the basis of the correlation information;
generating the plurality of synthesized transmission signals by performing the signal synthesis process on the plurality of transmission signals;
calculating a phase shift amount indicating a shift amount of the phase of each of the plurality of synthesized transmission signals, on the basis of the phase control information received by the reception unit; and
adjusting the phase of each of the plurality of synthesized transmission signals, by the phase shift amount calculated by the phase calculation unit.

This disclosure is not limited to the above-described examples and is allowed to be changed, if desired, without departing from the essence or spirit of the invention which can be read from the claims and the entire specification. A wireless communication system, a wireless communication method, a computer program, and a recording medium with such changes, are also included in the technical concepts of this disclosure.

### DESCRIPTION OF REFERENCE NUMERALS

1 Transmission apparatus
11 Signal processing apparatus
122 Signal synthesis unit
123 Phase unit
125 Feedback signal reception unit
126 Phase update unit
2 Reception apparatus
21 Signal processing apparatus
222 MIMO equalization processing unit
224 Communication state detection unit
225 Phase control information generation unit
226 Feedback signal generation unit
SYS Wireless communication system

What is claimed is:

1. A wireless communication system comprising:
a transmission apparatus that generates a plurality of synthesized transmission signals by performing a signal synthesis process on a plurality of transmission signals, and that transmits a wireless signal including a plurality of wireless transmission signals generated from the plurality of synthesized transmission signals, by using a plurality of transmitting antenna elements; and
a reception apparatus that receives the wireless signal transmitted by the transmission apparatus, as a plurality of wireless reception signals, by using a plurality of receiving antenna elements,
the reception apparatus including:
at least one first memory configured to store instructions; and
at least one first processor configured to execute the instructions to:
generate a plurality of separated reception signals by performing a signal separation process on the plurality of wireless reception signals;
generate correlation information indicating a correlation among the plurality of separated reception signals;
generate phase control information indicating a relationship between a phase of each of the plurality of synthesized transmission signals and a communication capacity, on the basis of the correlation information; and
transmit the phase control information to the transmission apparatus,
the transmission apparatus including:
at least one second memory configured to store instructions; and
at least one second processor configured to execute the instructions to:
receive the phase control information transmitted by the transmission unit;
generate the plurality of synthesized transmission signals by performing the signal synthesis process on the plurality of transmission signals;
calculate a phase shift amount indicating a shift amount of the phase of each of the plurality of synthesized transmission signals, on the basis of the phase control information received by the reception unit; and
adjust the phase of each of the plurality of synthesized transmission signals, by the phase shift amount calculated by the phase calculation unit.

2. The wireless communication system according to claim 1, wherein
the at least one first processor configured to execute the instructions to:
calculate the correlation including: a cross-correlation between a first separated reception signal of the plurality of separated reception signals and a complex conjugate of a second separated reception signal of the plurality of separated reception signals that is different from the first separated reception signal; and an autocorrelation between the first separated reception signal and a complex conjugate of the first separated reception signal; and
normalize the correlation by using a transmission signal power, thereby to generate the correlation information indicating the normalized correlation.

3. The wireless communication system according to claim 1, wherein
the at least one first processor configured to execute the instructions to:
generate a first square matrix with the correlation information as a matrix component, and
generate the phase control information by using imaginary components of diagonal components of a second square matrix that is obtained by multiplication of a unitary matrix used in the signal synthesis process, the first square matrix, and a Hermitian transposed matrix of the unitary matrix.

4. The wireless communication system according to claim 1, wherein
the at least one second processor configured to execute the instructions to:
calculate an update amount of the phase shift amount, on the basis of the phase control information received by the reception unit, and
calculate the phase shift amount by cumulatively adding the update amount to the phase shift amount to update the phase shift amount.

5. The wireless communication system according to claim 1, wherein
the plurality of transmitting antenna elements are N transmitting antenna elements arranged on a circumference of a first circle (where N is a variable indicating an integer of 2 or more),
the plurality of receiving antenna elements are N receiving antenna elements arranged on a circumference of a second circle, and
the at least one second processor configured to execute the instructions to perform the signal synthesis process by using a unitary matrix that is a discrete Fourier transform matrix with a length N.

6. A wireless communication method using:
a transmission apparatus that generates a plurality of synthesized transmission signals by performing a signal synthesis process on a plurality of transmission signals, and that transmits a wireless signal including a plurality of wireless transmission signals generated from the plurality of synthesized transmission signals, by using a plurality of transmitting antenna elements; and
a reception apparatus that receives the wireless signal transmitted by the transmission apparatus, as a plurality of wireless reception signals, by using a plurality of receiving antenna elements,
the wireless communication method comprising:
generating a plurality of separated reception signals by performing a signal separation process on the plurality of wireless reception signals;
generating correlation information indicating a correlation among the plurality of separated reception signals;
generating phase control information indicating a relationship between a phase of each of the plurality of synthesized transmission signals and a communication capacity, on the basis of the correlation information;
generating the plurality of synthesized transmission signals by performing the signal synthesis process on the plurality of transmission signals;
calculating a phase shift amount indicating a shift amount of the phase of each of the plurality of synthesized transmission signals, on the basis of the phase control information received by the reception unit; and
adjusting the phase of each of the plurality of synthesized transmission signals, by the phase shift amount calculated by the phase calculation unit.

7. A non-transitory recording medium on which a computer program that allows a computer to execute a wireless communication method is recorded,
the wireless communication method using:
a transmission apparatus that generates a plurality of synthesized transmission signals by performing a signal synthesis process on a plurality of transmission signals, and that transmits a wireless signal including a plurality of wireless transmission signals generated from the plurality of synthesized transmission signals, by using a plurality of transmitting antenna elements; and
a reception apparatus that receives the wireless signal transmitted by the transmission apparatus, as a plurality of wireless reception signals, by using a plurality of receiving antenna elements,
the wireless communication method including:
generating a plurality of separated reception signals by performing a signal separation process on the plurality of wireless reception signals;
generating correlation information indicating a correlation among the plurality of separated reception signals;
generating phase control information indicating a relationship between a phase of each of the plurality of synthesized transmission signals and a communication capacity, on the basis of the correlation information;
generating the plurality of synthesized transmission signals by performing the signal synthesis process on the plurality of transmission signals;
calculating a phase shift amount indicating a shift amount of the phase of each of the plurality of synthesized transmission signals, on the basis of the phase control information received by the reception unit; and
adjusting the phase of each of the plurality of synthesized transmission signals, by the phase shift amount calculated by the phase calculation unit.
